(19) United States
(12) Patent Application Publication
(10) Pub. No.: US 2017/0325421 A1
(43) Pub. Date: Nov. 16, 2017

(54) MOATED PET BOWL

(71) Applicant: David Do, Oak Hill, FL (US)

(72) Inventor: David Do, Oak Hill, FL (US)

(21) Appl. No.: 15/150,645

(22) Filed: May 10, 2016

(51) Int. Cl. A01K 5/01; A01K 7/00; A01K 5/02

(52) U.S. Cl. CPC A01K 5/0142; A01K 5/02; A01K 7/00

(57) ABSTRACT

A pet food bowl has three bowls, a first bowl for holding drinking water, a second bowl for holding water and providing a moat, and third bowl to be placed in the second bowl for holding the pet food. The water from the drinking bowl passes through a conduit to the second bowl, maintaining the water level in the second bowl. The third bowl may be removable to allow for easy cleaning of the second and third bowls.

### FIELD OF THE INVENTION

Feeding of domesticated animals is generally quite easy. One bowl for food and one for water are provided for the owner's pets. The owner puts dry (or even wet) food into the food bowl and water into the water bowl. The animals then can eat and drink whenever they are hungry or thirsty. However, in some climates and locales, this situation is less than ideal. Pests may also like to eat whenever they are hungry as well. The pests, and ants in particular, will find and take over the pet's food. This causes problems not only for the pets whose food is being tainted by the pests, but may also provide the pests with other options, including infesting other areas of the home, etc.

Thus, a pet bowl is needed to prevent the pests from entering the food bowl. While a moat around the food bowl is known, the present invention allows the water from a water dish to travel from the water dish to the moat around the food portion and maintain a constant water depth.

### SUMMARY OF THE INVENTION

The present invention is directed to a moated pet food bowl that includes a first bowl for holding water and having an opening in a sidewall thereof, a second bowl having an opening in a sidewall thereof, the second bowl disposed adjacent to and attached to the first bowl, a third bowl disposed at least partially within the second bowl, the third bowl for holding pet food, and a conduit disposed between the first and second bowls and connected to the openings in the sidewalls thereof so that the first bowl and the second bowl are in fluid communication with each other.

In some embodiments, the opening in the sidewall of the first bowl is higher than the opening in the sidewall of the second bowl.

In some other embodiments, the third bowl has a lip extending outward to at least partially cover the gap when the third bowl is disposed within the second bowl.

According to another aspect of the present invention, a moated pet food bowl includes a first bowl for holding water having a bottom and a side wall extending around the bottom to form a water holding portion, the first bowl having an opening in the side wall, a second bowl having a bottom and a side wall extending around the bottom, the second bowl having an opening in the sidewall, the second bowl disposed adjacent to and attached to the first bowl, a third bowl having an outside perimeter, the outside perimeter being smaller than an inside perimeter of the second bowl such that the third bowl fits at least partially within the second bowl, the third bowl for holding pet food, and a conduit disposed between the first and second bowls and connected to the openings in the sidewalls thereof so that the first bowl and the second bowl are in fluid communication with each other.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of one embodiment of a moated pet bowl according to the present invention with supply bottles that can be used therewith;

FIG. 2 is an exploded perspective view of the moated pet bowl of FIG. 1;

FIG. 3 is a cross sectional view of the moated pet bowl of FIG. 1 along line 3-3;

FIG. 4 is a cross sectional view of the moated pet bowl of FIG. 1 along line 4-4;

FIG. 5 is a cross sectional view of the moated pet bowl of FIG. 1 along line 5-6;

FIG. 6 is a front view of the moated pet bowl of FIG. 1;

FIG. 7 is a top view of the moated pet bowl of FIG. 1;

FIG. 8 is an exploded top view of the moated pet bowl of FIG. 7

FIG. 9 is a rear view of the moated pet bowl of FIG. 1 illustrating one embodiment of clamp that can be used to secure the moated pet bowl; and

FIG. 10 is rear cross sectional view of an alternative embodiment of a conduit used to join the two bowls together in fluid communication.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

Referring to the figures, a moated pet bowl 10 has a first bowl 100 and a second bowl 200, the first bowl 100 and the second bowl 200 being attached to one another. The first bowl 100 and the second bowl 200 are preferably attached to one another with supports 12, 14. As illustrated, the first bowl 100 and the second bowl 200 are made from metal and the supports 12,14, also made of metal, are welded to the bowls 100,200. However, the pet bowl 10 may be made of any appropriate materials, including but not limited to plastic, steel, aluminum, or other appropriate materials. While the supports 12,14 are illustrated as attaching to sides of the bowls 100,200, they could be attached in other ways and/or manner. For example, they could be attached by the bottoms or the tops of the bowls 100,200, and the bowls 100,200 could also share a common wall.

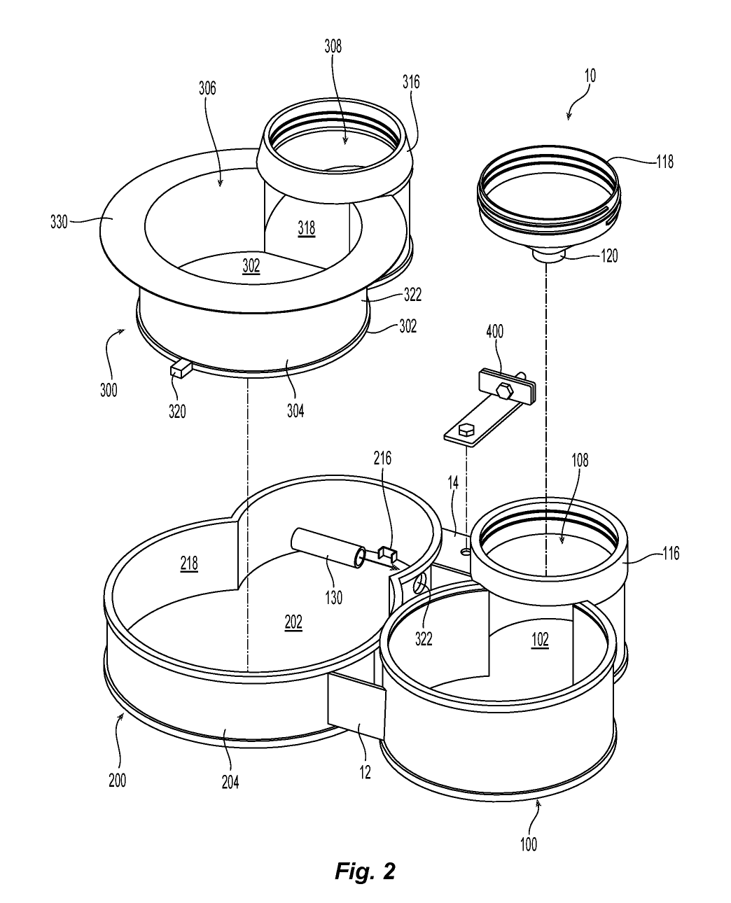

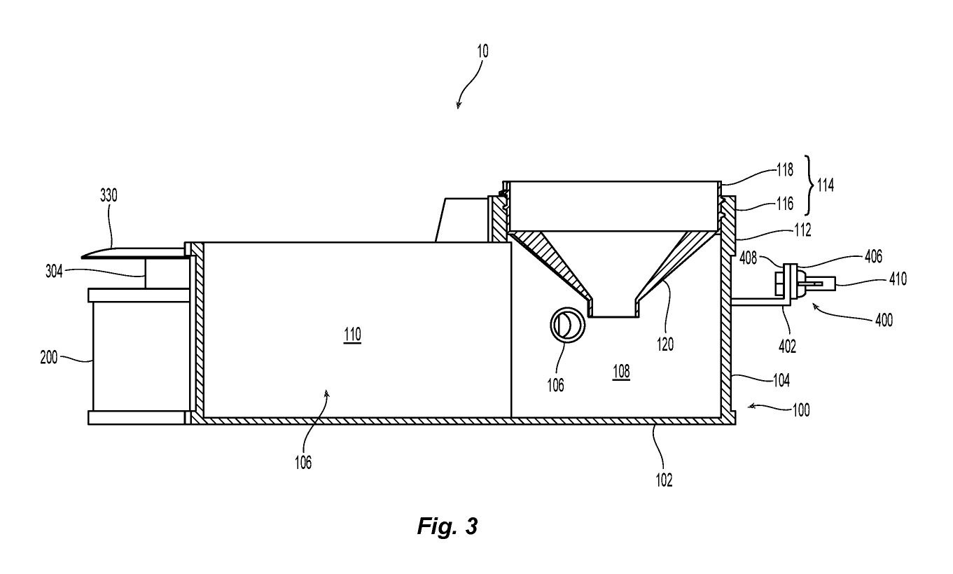

The moated pet bowl 10 also has a third bowl 300, which is inserted into the second bowl 200. See, e.g., FIGS. 2 and 3. As described in more detail below, the first bowl 100 is designed to hold water for the pet that will be using the moated pet bowl 10. The second bowl 200 is designed to be the moat as it is in fluid communication with and receives water from the first bowl 100 and in particular, from water bottle WB. The third bowl 300 holds the dry pet food. The third bowl 300 is preferably removably inserted into the second bowl 200 with space therearound to allow water from the first bowl 100 to surround the third bowl 300 to make a moat, preventing pests from being able to access the pet food in the third bowl 300 due to the water barrier between the second bowl two hundred 200 and the third bowl 300.

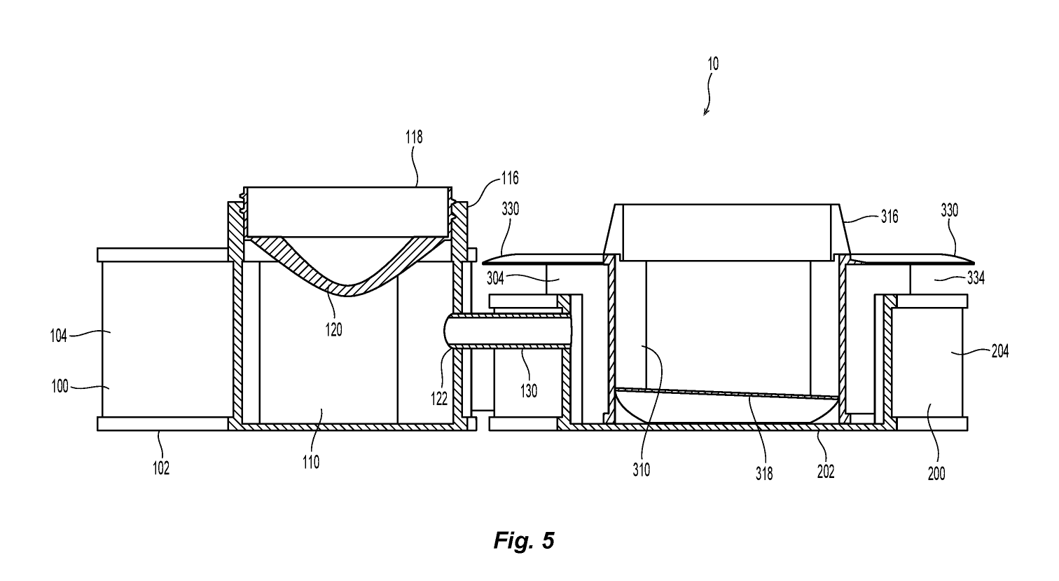

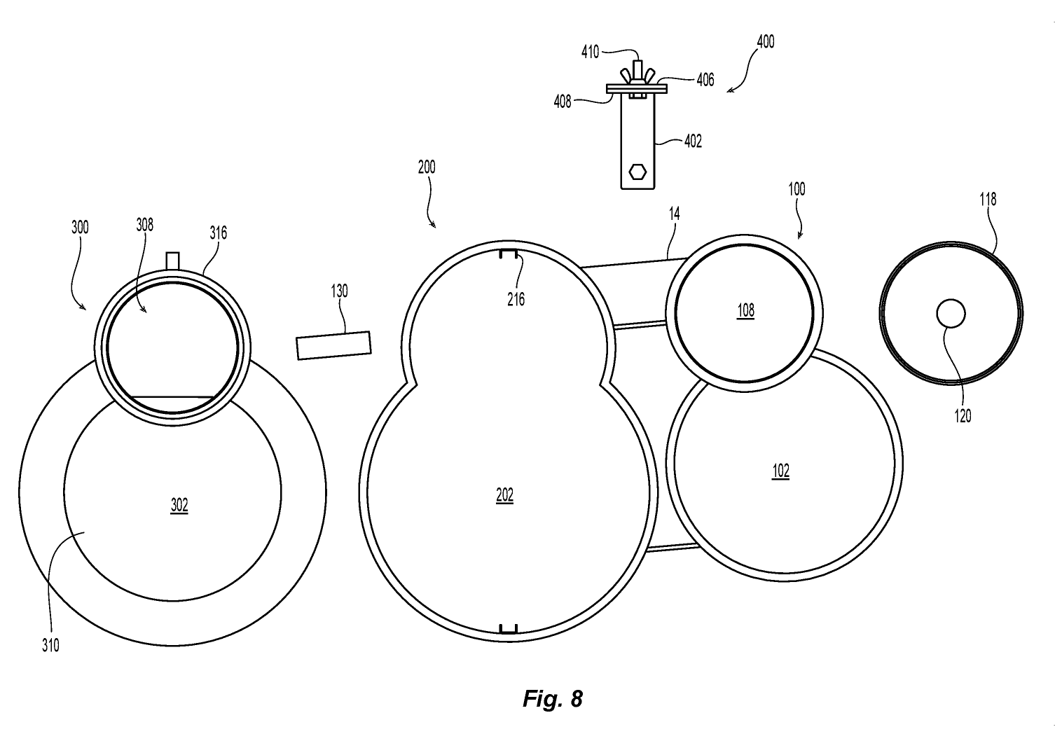

As best seen in FIGS. 2, 3, and 5, the first bowl 100 has a bottom 102 and a side wall 104 that encircles the bottom 102. The first bowl 100 has a shape that approximates a FIG. 8, but could be of any appropriate shape, including more of an oval or rectangular shape (with rounded corners if desired). By using this configuration, Applicant has eliminated tight corners to allow for easier cleaning and safety as there are no sharp edges or corners to accumulate old food or to injure the persons or the pets using the bowl. While there appears to be a seam between the bottom 102 and the side wall 104, the two elements could be formed simultaneously, with the bottom 102 and the side wall 104 forming a unitary structure. There may also be a smoother or curved transition between the bottom 102 and the side wall 104, eliminating the 90 degree corners (see, e.g., FIGS. 3 and 5), further improving the ability to clean the moated pet bowl 10.

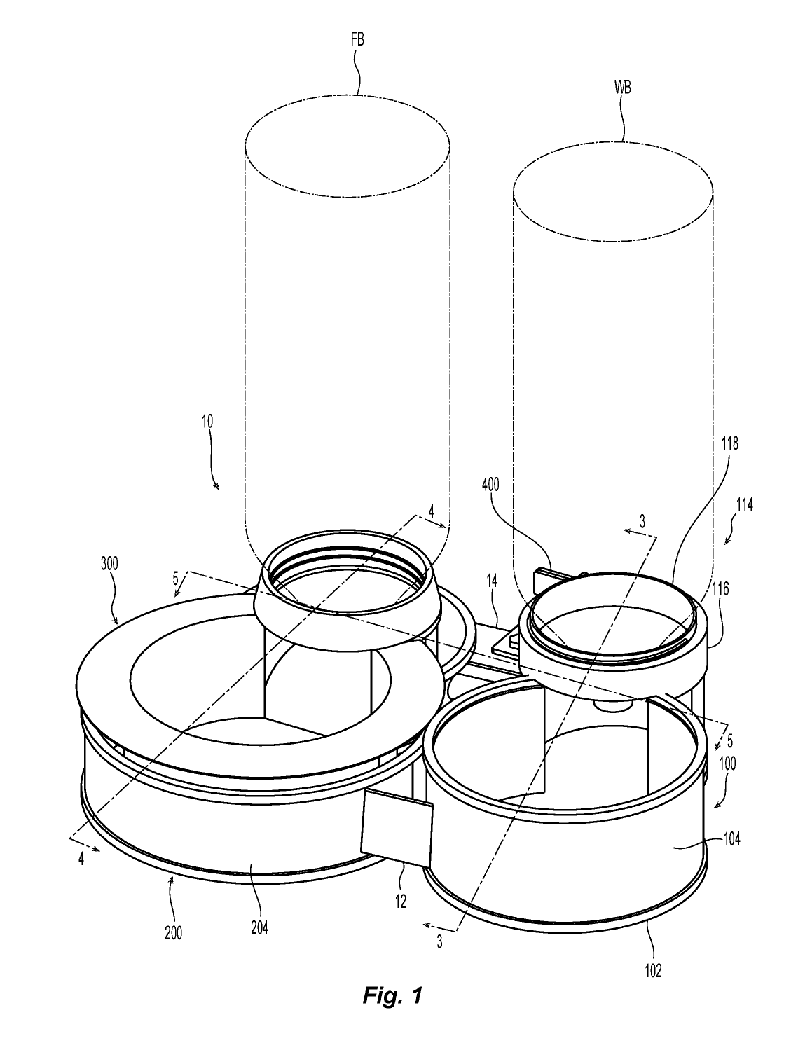

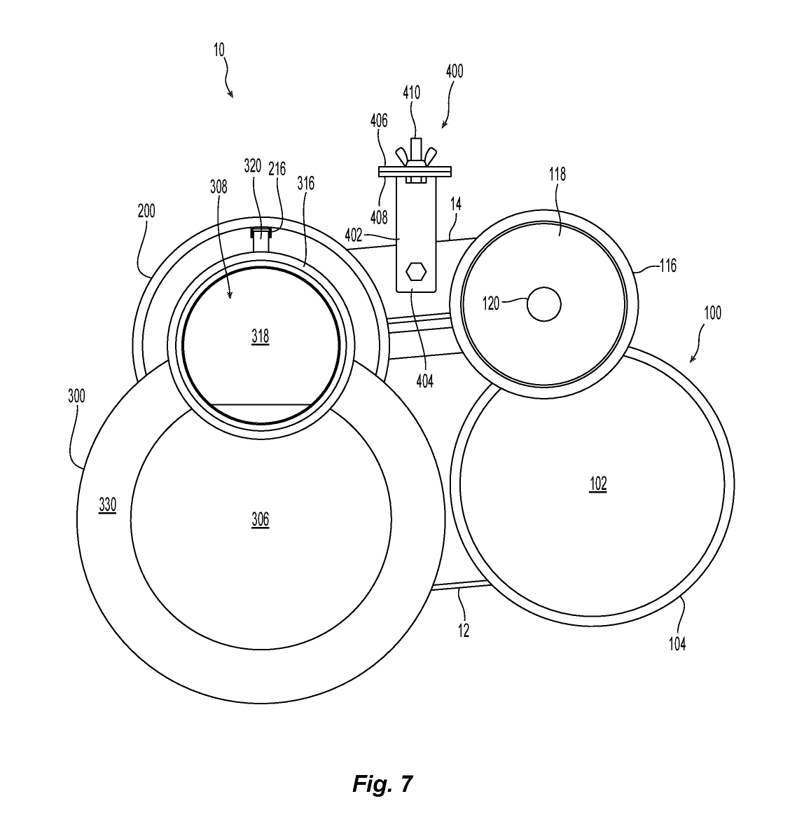

Returning to the first bowl 100, the bottom 102 and the side wall 104 form a water holding portion 106, which is divided into a supply area 108 and a drinking area 110. On the top edge 112 of the supply area 108 is a bottle holding member 114. The bottle holding member 114 has a first ring portion 116 that is preferably attached to at least a portion of the side wall 104 and a disbursing portion 118. While the bottle holding member 114 is fixedly attached as illustrated, it could also be removable. The disbursing portion 118 holds a source of water, a water bottle such as the water bottle WB in FIG. 1, and preferably has a lower portion to 120 control the flow of water from the water bottle (see e.g., FIGS. 3, 5, and 7) into the supply area 108. The lower portion 120 is preferably funnel-shaped but could be any appropriate configuration. The top part of the disbursing portion 118 may be configured to accept a variety of water supply bottles and sizes of openings, including specialized bottles or more prevalent water bottles that are available from numerous retailers. The length of the lower portion 120 may also be altered, depending on the depth of water that is needed in the first bowl 100. For a shallower water line in the first bowl 100, the lower portion 120 would be closer to the bottom 102 and farther away from the bottom 102 for a higher water line. However, the water line in supply area 108 needs to be at least as high as the opening 122 as discussed below.

The water bottle WB is illustrated as a tall, thin water bottle, but it could be of any shape or size. For example, the water bottle WB could be a regular 16 ounce water bottle, or a much larger diameter and shorter water bottle. The water bottle WB could simply sit within the disbursing portion 118, or be secured within the disbursing portion 118 with threads on the water bottle WB and the disbursing portion 118 or in any other fashion.

The first bowl 100 also has an opening 122 in the side wall 104, see FIGS. 3 and 5, that is connected to a conduit 130, which joins the first bowl 100 with the second bowl 200, as discussed below in more detail. The conduit 130 is illustrated as a cylinder but could be of any shape in cross section—oval, square, etc. and still fall within the scope of the present invention. While is it not the most preferred embodiment, the conduit 130 may have a lengthwise opening giving it a u-shaped cross section.

The second bowl 200 has a bottom 202 and a side wall 204 and has a shape that also approximates a FIG. 8. However, as noted above with regard to the first bowl 100, it could be of any appropriate shape and made of any appropriate materials. The bottom 202 and the side wall 204 could be formed simultaneously, with the bottom 202 and the side wall 204 forming a unitary structure for the same reasons as given for the first bowl 100.

The bottom 202 and the side wall 204 form a water holding portion 206 (and as is clear from the figures, also holds third bowl 300). The second bowl 200 also has an opening 222 in the side wall 204, see FIGS. 2 and 5, that is connected to the conduit 130, which connects the second bowl 200 with the first bowl 100 to allow water to flow from the first bowl 100 to the second bowl 200. The second bowl 200 also includes alignment members 216, which are attached to the bottom 202 and the side wall 204 to center the third bowl 300. The third bowl 300 will have cooperating structures to engage the alignment members 216. The alignment members 216 may only be attached to one of the bottom 202 and the side wall 204 if so desired. For obvious reasons, the third bowl 300 is preferably removable from the second bowl 200 to allow for cleaning of both second bowl 200 and third bowl 300.

The third bowl 300 has a bottom 302 and a side wall 304 and has a shape that preferably approximates the shape of the second bowl 200. In the embodiment illustrated, that shape is a FIG. 8, but could be any shape that fits inside the second bowl 200. The bottom 302 and the side wall 304 form a pet food holding portion 306, which is divided into a supply area 308 and an eating area 310. Attached to the top edge 312 of the side wall 304 in the supply area 308 is a bottle holding member 316. The third bowl 300 also has a disbursing portion 318 in the supply area 308 and under the bottle holding member 316 to control the flow of pet food from a supply bottle FB (see e.g., FIG. 1). The disbursing portion 318 is preferably an inclined surface (and may also be a portion of the bottom 302), which directs the pet food from the bottle in the supply area 308 into the eating area 310. While the disbursing portion 318 is illustrated as a flat inclined surface, it could be concave or have another shape (more funnel-like) that would direct the pet food into the eating area 310.

The food bottle FB is illustrated as a tall, thin bottle, but it could be of any shape or size. The opening in the food bottle FB needs to be large enough that the food does not get caught in the opening. For example, the food bottle WB could be a tall slender bottle that may match the water bottle WB, or a much larger diameter and shorter water bottle. The food bottle FB preferably has threads to match to match those in the bottle holding member 316.

Attached to the outside of the third bowl 300 at the bottom 302 are two projections 320 that engage and cooperate with the alignment members 216. See FIGS. 2 and 8. When the third bowl 300 is inserted into the water holding portion 206 of second bowl 200, the projections 320 fit between the alignment members 216 to center the third bowl 300 within the second bowl 200. This ensures that water from the first bowl 100 that enters the second bowl 200 through conduit 130 (or could alternatively be added directly to the second bowl 200 by the pet owner) completely surrounds the third bowl 300. In this manner, the pet food in the third bowl 300 is isolated from the pests by the water—since the pests will not be able to cross over the water in the second bowl 200. As would be obvious to one of ordinary skill in the art, the projections 320 and the alignment members 216 could be reversed with the projections on the second bowl 200 and the alignment members on the third bowl 300. The alignment members and the projections 216,320 could take other forms and still fall within the scope of the present invention as long as they would keep the water around the third bowl 300.

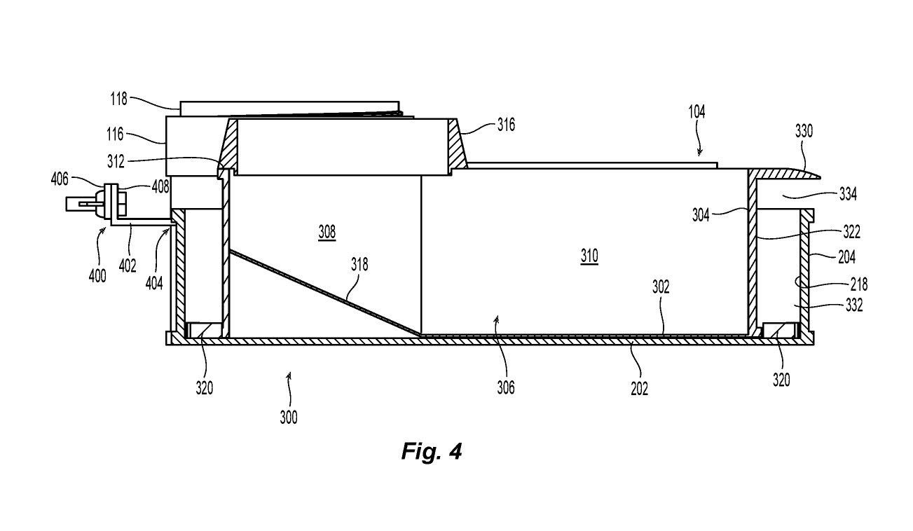

The third bowl 300 also preferably has an extended lip 330 that extends radially outward from the side wall 304 in the eating area 310. In this manner, the extended lip 330 covers the area 332 that is formed between the inside surface 218 of side wall 204 of the second bowl and the outside surface 322 of the side wall 302 of the third bowl 300. As best illustrated in FIG. 4, the lip 330 extends outward beyond the sidewall 204 of the second bowl 200. The extended lip 330 provides another barrier to pests that may want to get to the food in third bowl 300 and also prevents the pet eating the food from allowing food to drop into the area 332. If food were to enter the area 332, it would potentially provide a path from the second bowl 200 to the third bowl 300 as well as fouling the water in the second bowl 200. The lip 330 provides a space 334 between its self and the top of the side wall 204 so that the pests cannot simply bypass the area 332 by climbing from the sidewall 204 to the lip 330. As is illustrated in the figures, especially FIG. 3, the side wall 104 is higher (wider) than the side wall 204, but could be the same height or even smaller (taking into account the conduit 130 between the first and second bowls 100,200) if so desired.

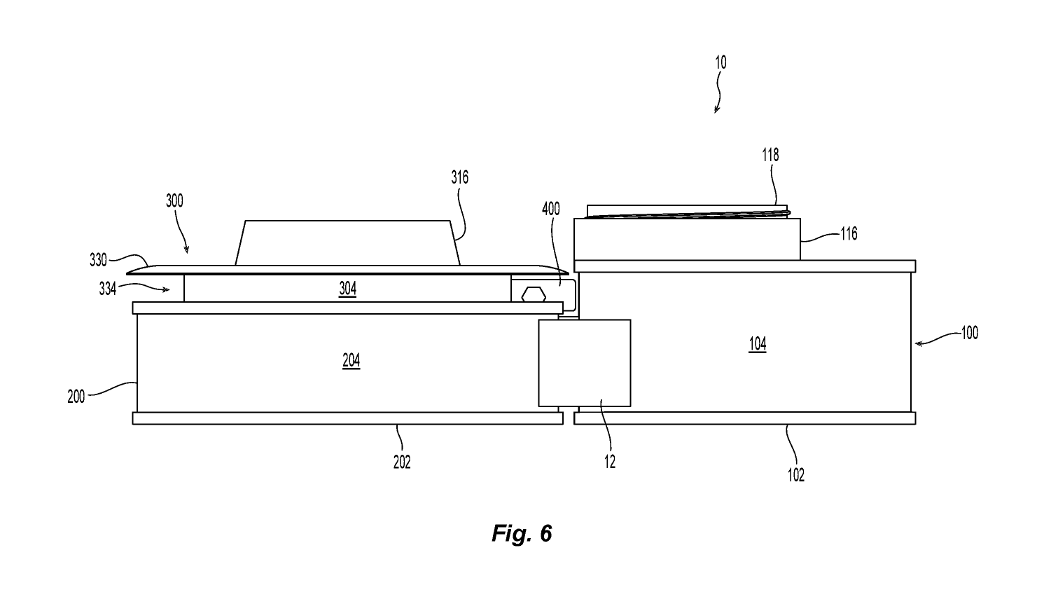

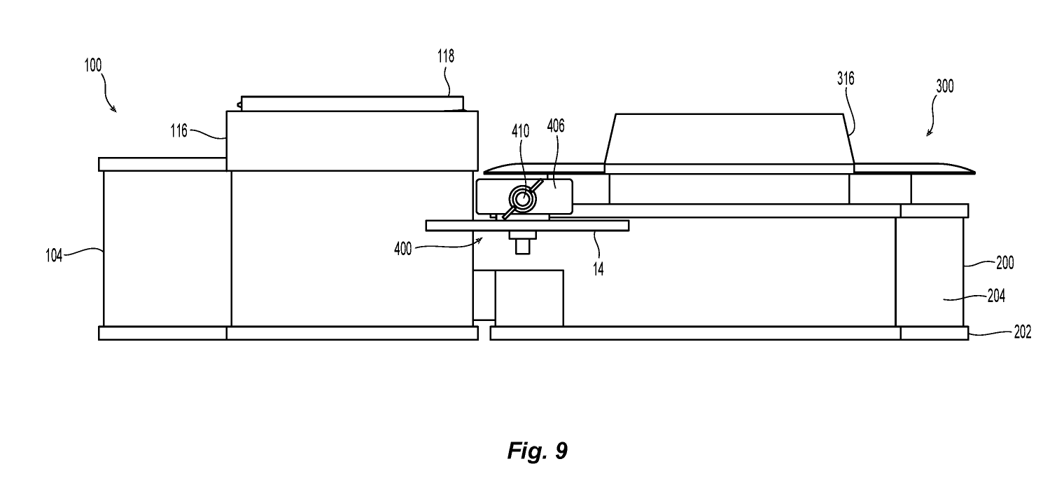

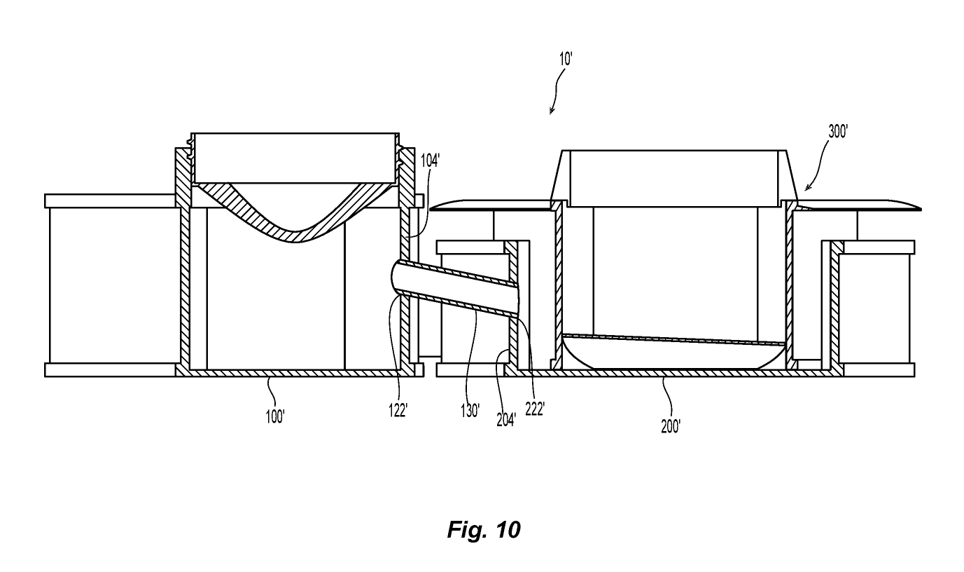

As illustrated in FIGS. 1-9, the conduit 130 is level between the first bowl 100 and the second bowl 200. However, as illustrated in an alternative embodiment of a moated pet bowl 10′ in FIG. 10, the conduit 130′ at the first bowl 100′ may be slightly higher (and the opening 122′ is higher in wall 104′) than the opening 222′ in the side wall 204′ at the second bowl to prevent water from the second bowl 200′ from entering the first bowl 100′—and perhaps contaminating the water that the pet drinks. However, with this arrangement, the water in the second bowl 200′, and the moat, is maintained as long as there is water in the supply bottle.

A clamp 400 is provided to secure the moated pet bowl 10 to another structure. The clamp 400 may take any form but has an arm 402 that is adjustably attached to the support 14 at one end 404 with a wing nut 410 and is attached to a bar 406 at the second end 408. The bar 406 and the second end 408 can have inserted therebetween the other structure to prevent the moated pet bowl from be easily moved.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A moated pet food bowl comprising:
a first bowl for holding water and having a first sidewall and a first opening therein, the first sidewall having an inner surface and an outer surface;
a second bowl having a second sidewall and a second opening therein, the second sidewall having an inner surface and an outer surface and the second bowl disposed adjacent to and attached to the first bowl;
a third bowl disposed at least partially within the second bowl, the third bowl for holding pet food; and
an elongated conduit disposed between the outer surfaces of the first and second sidewalls and connected to the openings in the sidewalls thereof so that the first bowl and the second bowl are in fluid communication with each other.

2. The moated pet food bowl according to claim 1, wherein the third bowl is removable from the second bowl.

3. The moated pet food bowl according to claim 1, wherein the opening in the sidewall of the first bowl is higher than the opening in the sidewall of the second bowl.

4. The moated pet food bowl according to claim 1, wherein the second bowl has a inner surface and the third bowl has an outer surface, the second and third bowls forming a gap between the inner and outer surfaces when the third bowl is disposed within the second bowl.

5. The moated pet food bowl according to claim 4, wherein the third bowl has a lip extending outward to at least partially cover the gap when the third bowl is disposed within the second bowl.

6. The moated pet food bowl according to claim 1, wherein the first and third bowls have receptacles to engage a supply bottle.

7. The moated pet food bowl according to claim 1, further comprising a clamp, the clamp configured to attach the pet food bowl to a structure.

8. The moated pet food bowl according to claim 1, wherein the conduit is a cylinder.

9. The moated pet food bowl according to claim 6, wherein the first bowl has a first and a second section, the receptacle being disposed in the second section and the first section open to a pet.

10. The moated pet food bowl according to claim 6, wherein the third bowl has a first and a second section, the receptacle being disposed in the second section and the first section receives food from the receptacle in the second section for the pet.

11. A moated pet food bowl comprising:
a first bowl for holding water having a bottom and a first sidewall, the first sidewall having an inner surface and an outer surface, the sidewall extending around the bottom to form a water holding portion, the first bowl having an opening in the sidewall;
a second bowl having a bottom and a second sidewall extending around the bottom, the second bowl having an opening in the second sidewall, the second bowl disposed adjacent to and attached to the first bowl;
a third bowl having an outside perimeter, the outside perimeter being smaller than an inside perimeter of the second bowl such that the third bowl fits at least partially within the second bowl, the third bowl for holding pet food; and
a conduit disposed between the outer surfaces of the first and second bowls and connected to the openings in the sidewalls thereof so that the first bowl and the second bowl are in fluid communication with each other.

12. The moated pet food bowl according to claim 11, wherein the third bowl is removable from the second bowl.

13. The moated pet food bowl according to claim 11, wherein the opening in the sidewall of the first bowl is higher than the opening in the sidewall of the second bowl.

14. The moated pet food bowl according to claim 11, wherein the second bowl has a inner wall and the third bowl has an outer wall, the second and third bowls forming a gap between the inner and outer walls when the third bowl is disposed within the second bowl.

15. The moated pet food bowl according to claim 14, wherein the third bowl has a lip extending outward to at least partially cover the gap when the third bowl is disposed within the second bowl.

16. The moated pet food bowl according to claim 11, wherein the first and third bowls have receptacles to engage a supply bottle.

17. The moated pet food bowl according to claim 11, further comprising a clamp, the clamp configured to attach the pet food bowl to a structure.

18. The moated pet food bowl according to claim 11, wherein the conduit is a cylinder.

19. The moated pet food bowl according to claim 16, wherein the first bowl has a first and a second section, the receptacle being disposed in the second section and the first section open to a pet.

20. The moated pet food bowl according to claim 16, wherein the third bowl has a first and a second section, the receptacle being disposed in the second section and the first section receives food from the receptacle in the second section for the pet.
